(19) United States
(12) Patent Application Publication
(10) Pub. No.: US 2013/0212354 A1
(43) Pub. Date: Aug. 15, 2013

(54) Method for efficient data array sorting in a programmable processor

(71) Applicant: Tibet Mimar, Morgan Hill, CA (US)

(72) Inventor: Tibet Mimar, Morgan Hill, CA (US)

(21) Appl. No.: 12/586,356

(22) Filed: Sep. 20, 2009

(51) Int. Cl. G06F 9/30; G06F 15/76

(52) U.S. Cl. 712/4; 712/E09.023

(57) ABSTRACT

The present invention provides a method for performing data array sorting of vector elements in a N-wide SIMD that is accelerated by a factor of about N/2 over scalar implementation excluding scalar load/store instructions. A vector compare instruction with ability to compare any two vector elements in accordance to optimized data array sorting algorithms, followed by a vector-multiplex instruction which performs exchanges of vector elements in accordance with condition flags generated by the vector compare instruction provides an efficient but programmable method of performing data sorting with a factor of about N/2 acceleration. A mask bit prevents changes to elements which is not involved in a certain stage of sorting.

### BACKGROUND OF THE INVENTION

1. Field of the Invention

The invention relates generally to the field of processor chips and specifically to the field of single-instruction multiple-data (SIMD) processors. More particularly, the present invention relates to sorting of data arrays in a SIMD processor.

2. Description of the Background Art

SIMD processors typically have vector-compare-and-select-larger type instructions for comparing respective elements of two source vectors and choosing the larger one for each vector element position. This assumes that each compare-exchange operation would require one such vector instruction, and we could perform these in parallel on N pixels. For example, sorting of 16 numbers would require 61 compare-exchange modules. This means for each exchange module we would use one select-larger and one select smaller to perform the exchange, which would require 2*61, or 122 instruction for N outputs in parallel. We would also have to load two vectors with different offsets according to the algorithm, which means 61*2 vector load instructions. Sorting of 16 data elements would then require 122 sorting instructions and 122 vector load instructions. The total instructions is then 244. It is therefore not possible to get acceleration by a factor of N for a N-wide SIMD parallelism for data sorting.

The main difficulty arises from the need to compare any element of a source vector with any of its other element, and setting the condition flag accordingly. Such a capability is not provided in SIMD processors. Furthermore, ability to interchange to intra elements of a source vector is also not provided in today's SIMD processors.

### SUMMARY OF THE INVENTION

The present invention provides a method for performing data array sorting in a N-wide SIMD that is accelerated by a factor of N over scalar implementation. A vector compare instruction with ability to compare any two vector elements in accordance to optimized data array sorting algorithms, followed by a vector-multiplex instruction which performs exchanges of vector elements in accordance with condition flags generated by the vector compare instruction provides an efficient but programmable method of performing data sorting with a factor of N acceleration. A mask bit prevents changes to elements which is not involved in a certain stage of sorting.

The method of present invention provides an efficient sorting of data array elements. Sorting of 16 elements based on a optimized algorithm in Knuth requires 61 compare-exchange modules in 9 stages of processing. The present method performs this in 18 instruction pairs of vector-compare and vector-multiplex. The present invention has applications in efficient implementation median and rank filters in video processing as well as other data sorting and merge applications.

### BRIEF DESCRIPTION OF DRAWINGS

The accompanying drawings, which are incorporated and form a part of this specification, illustrate prior art and embodiments of the invention, and together with the description, serve to explain the principles of the invention.

FIG. 1 shows detailed block diagram of the SIMD processor.

FIG. 2 shows details of the select logic and mapping of source vector elements.

FIG. 3 shows the details of enable logic and the use of vector-condition-flag register.

FIG. 4 shows different supported SIMD instruction formats.

FIG. 5 shows block diagram of dual-issue processor consisting of a RISC processor and SIMD processor.

FIG. 6 illustrates executing dual-instructions for RISC and SIMD processors.

FIG. 7 shows the programming model of combined RISC and SIMD processors.

FIG. 8 shows an example of vector load and store instructions that are executed as part of scalar processor.

FIG. 9 shows an example of vector arithmetic instructions.

FIG. 10 shows an example of vector-accumulate instructions.

FIG. 11 shows vector condition flag selection and VCMP condition select syntax.

FIG. 12 shows the operation VMUX instruction.

FIG. 13 shows data sorting example using 4 data inputs and stage 3 of sorting.

FIG. 14 shows data sorting example using 4 data inputs and stage 2 of sorting.

FIG. 15 shows data sorting algorithm for 16 data inputs.

FIG. 16 shows implementation of sorting of 16 data inputs.

### DETAILED DESCRIPTION

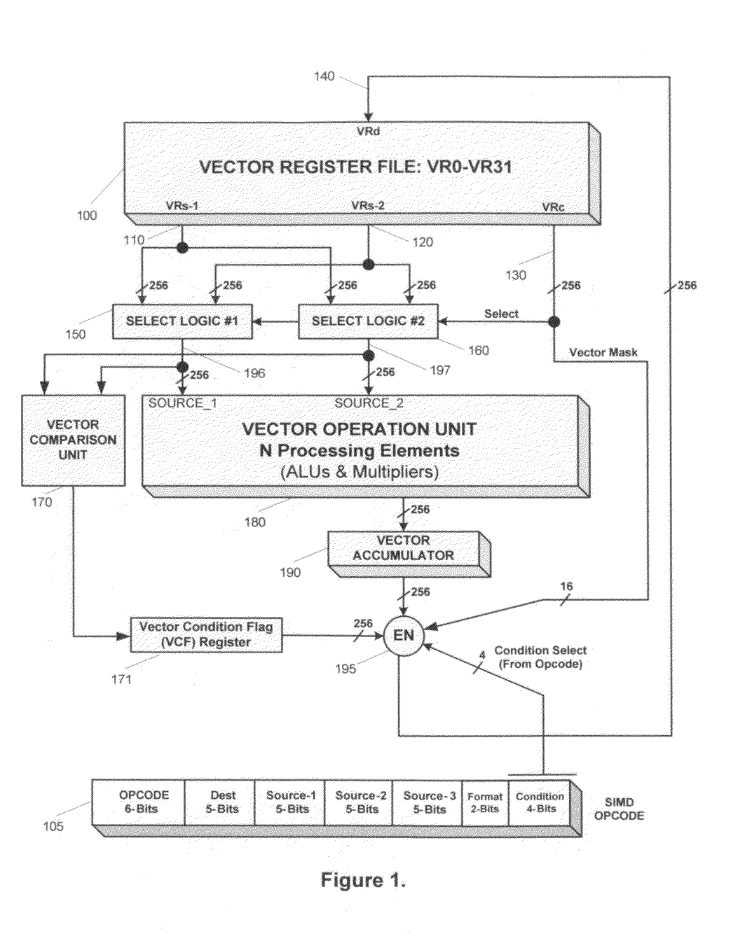

The SIMD unit consists of a vector register file 100 and a vector operation unit 180, as shown in FIG. 1. The vector operation unit 180 is comprised of plurality of processing elements, where each processing element is comprised of ALU and multiplier. Each processing element has a respective 48-bit wide accumulator register for holding the exact results of multiply, accumulate, and multiply-accumulate operations. These plurality of accumulators for each processing element form a vector accumulator 190. The SIMD unit uses a load-store model, i.e., all vector operations uses operands sourced from vector registers, and the results of these operations are stored back to the register file. For example, the instruction “VMUL VR4, VR0, VR31” multiplies sixteen pairs of corresponding elements from vector registers VR0 and VR31, and stores the results into vector register VR4. The results of the multiplication for each element results in a 32-bit result, which is stored into the accumulator for that element position. Then this 32-bit result for element is clamped and mapped to 16-bits before storing into elements of destination register.

Vector register file has three read ports to read three source vectors in parallel and substantially at the same time. The output of two source vectors that are read from ports VRs-1 110 and from port VRs-2 120 are connected to select logic 150 and 160, respectively. These select logic map two source vectors such that any element of two source vectors could be paired with any element of said two source vectors for vector operations and vector comparison unit inputs 170. The mapping is controlled by a third source vector VRc 130. For example, for vector element position #4 we could pair element #0 of source vector #1 that is read from the vector register file with element #15 of source vector #2 that is read from VRs-2 port of the vector register file. As a second example, we could pair element #0 of source vector #1 with element #2 of source vector #1. The output of these select logic represents paired vector elements, which are connected to SOURCE_1 196 and SOURCE_2 197 inputs of vector operation unit 180 for dyadic vector operations.

The output of vector accumulator is conditionally stored back to the vector register files in accordance with a vector mask from the vector control register elements VRc 130 and vector condition flags from the vector condition flag register VCF 171. The enable logic of 195 controls writing of output to the vector register file.

Vector opcode 105 for SIMD has 32 bits that is comprised of 6-bit opcode, 5-bit fields to select for each of the three source vectors, source-1, source-2, and source-3, 5-bit field to select one of the 32-vector registers as a destination, condition code field, and format field. Each SIMD instruction is conditional, and can select one of the 16 possible condition flags for each vector element position of VCF 171 based on condition field of the opcode 105.

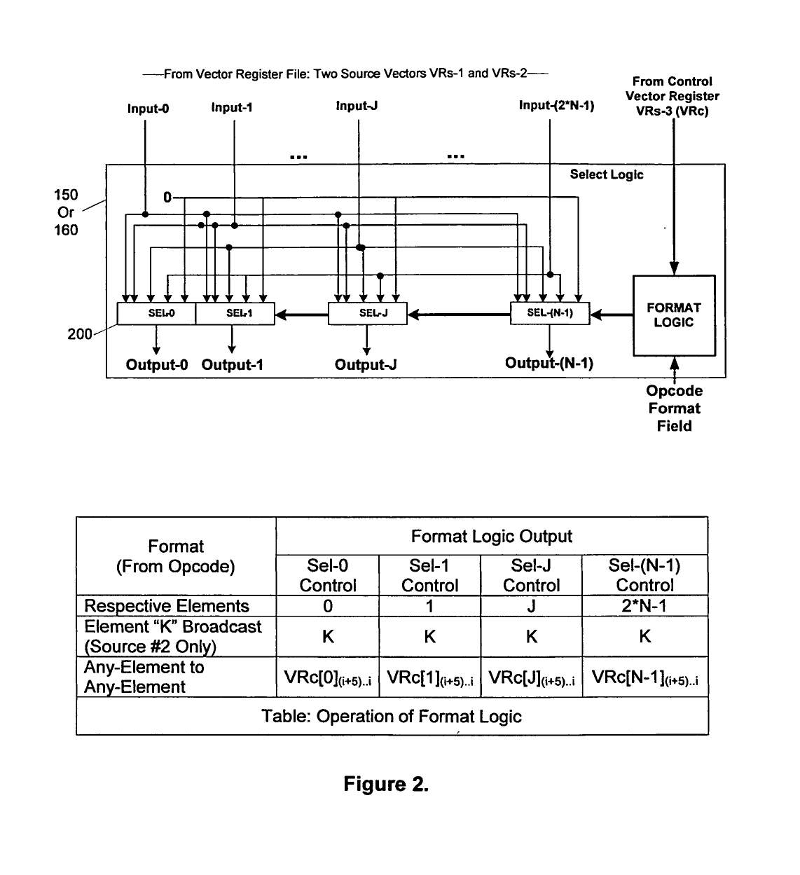

The details of the select logic 150 or 160 is shown in FIG. 2. Each select logic for a given vector element could select any one of the input source vector elements or a value of zero. Thus, select logic units 150 and 160 constitute means for selecting and pairing any element of first and second input vector register with any element of first and second input vector register as inputs to operators for each vector element position in dependence on control register values for respective vector elements.

The select logic comprises of N select circuits, where N represents the number of elements of a vector for N-wide SIMD. Each of the select circuit 200 could select any one of the elements of two source vector elements or a zero. Zero selection is determined by a zero bit for each corresponding element from the control vector register. The format logic chooses one of the three possible instruction formats: element-to-element mode (prior art mode) that pairs respective elements of two source vectors for vector operations, Element “K” broadcast mode (prior art mode), and any-element-to-any-element mode including intra elements (meanings both paired elements could be selected from the same source vector).

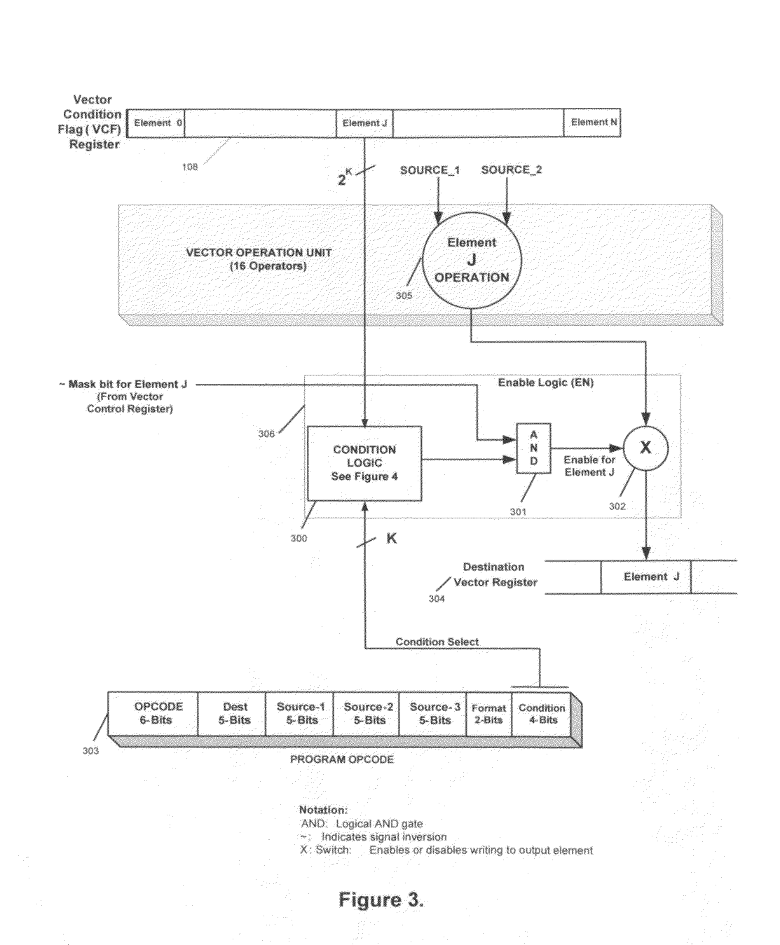

FIG. 3 shows the operation of conditional operation based on condition flags in VCF from a prior instruction sequence and mask bit from vector control register. The enable logic of 306 comprises Condition Logic 300 to select one of the 16 condition flags for each vector element position of VCF, AND logic 301 to combine condition logic output and mask, and as a result to enable or disable writing of vector operation unit into destination vector register 304 of vector register file.

In one preferred embodiment, each vector element is 16-bits and there are 16 elements in each vector. The control bit fields of control vector register is defined as follows:
Bits 4-0: Select source element from S2∥S-1 elements concatenated;
Bits 9-5: Select source element from S1∥S-2 elements concatenated;
Bit 10: 1→Negate sign of mapped source #2; 0→No change.
Bit 11: 1→Negate sign of accumulator input; 0→No change.
Bit 12: Shift Down mapped Source_1 before operation by one bit.
Bit 13: Shift Down mapped Source_2 before operation by one bit.
Bit 14: Select Source_2 as zero.
Bit 15: Mask bit, when set to a value of one, it disables writing output for that element.

| | Element Selection |
|---|---|
| Bits 4-0 | |
| 0 | VRs-1[0] |
| 1 | VRs-1[1] |
| 2 | VRs-1[2] |
| 3 | VRs-1[3] |
| 4 | VRs-1[4] |
| . . . | . . . |
| 15 | VRs-1[15] |
| 16 | VRs-2[0] |
| 17 | VRs-2[1] |
| 18 | VRs-2[2] |
| 19 | VRs-2[3] |
| . . . | . . . |
| 31 | VRs-2[15] |
| Bits 9-5 | |
| 0 | VRs-2[0] |
| 1 | VRs-2[1] |
| 2 | VRs-2[2] |
| 3 | VRs-2[3] |
| 4 | VRs-2[4] |
| . . . | . . . |
| 15 | VRs-2[15] |
| 16 | VRs-1[0] |
| 17 | VRs-1[1] |
| 18 | VRs-1[2] |
| 19 | VRs-1[3] |
| . . . | . . . |
| 31 | VRs-1[15] |

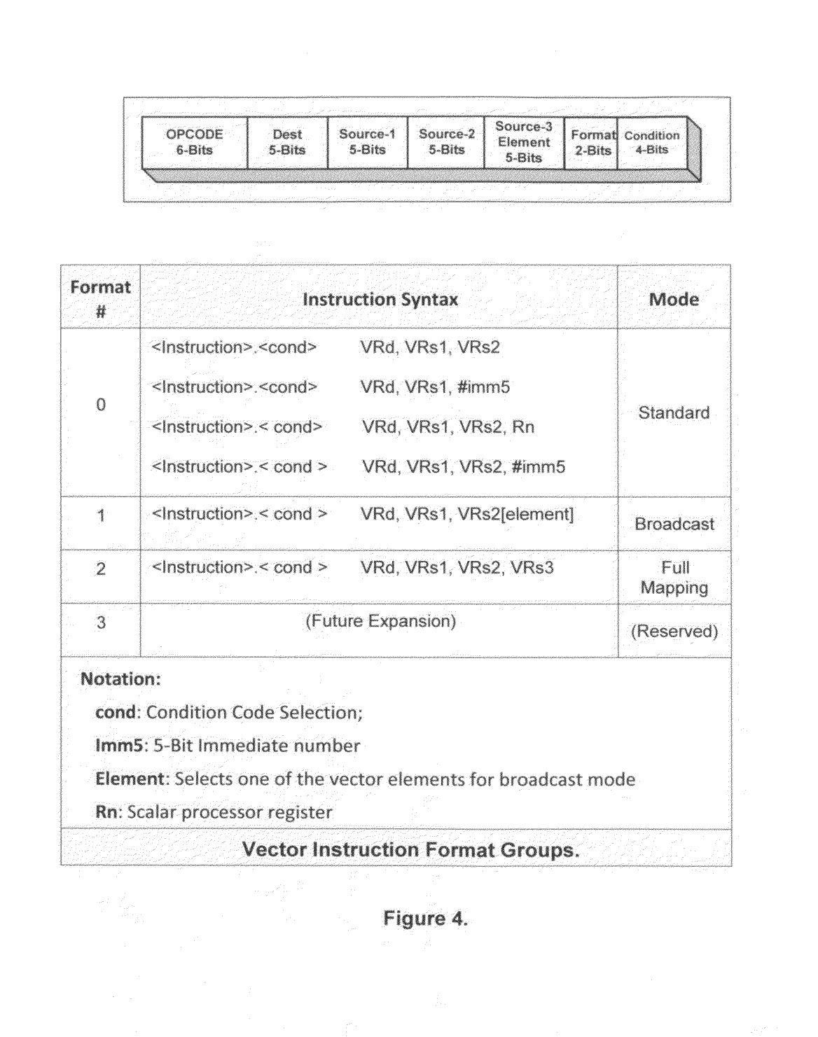

There are three vector processor instruction formats in general as shown in FIG. 4, although this may not apply to every instruction. Format field of opcode selects one of these three SIMD instruction formats. Most frequently used ones are:

| | |
|---|---|
| <Vector Instruction>.<cond> | VRd, VRs-1, VRs-2 |
| <Vector Instruction>.<cond> | VRd, VRs-1, VRs-2 [element] |
| <Vector Instruction>.<cond> | VRd, VRs-1, VRs-2, VRs-3 |

The first form (format=0) uses operations by pairing respective elements of VRs-1 and VRs-2. This form eliminates the overhead to always specify a control vector register. The second form (format=1) with element is the broadcast mode where a selected element of one vector instruction operates across all elements of the second source vector register. The form with VRs-3 is the general vector mapping mode form, where any two elements of two source vector registers could be paired. The word “mapping” in mathematics means “A rule of correspondence established between sets that associates each element of a set with an element in the same or another set”. The word mapping herein is used to mean establishing an association between a said vector element position and a source vector element and routing the associated source vector element to said vector element position.

The present invention provides signed negation of second source vector after mapping operation on a vector element-by-element basis in accordance with vector control register. This method uses existing hardware, because each vector position already contains a general processing element that performs arithmetic and logical operations. The advantage of this is in implementing mixed operations where certain elements are added and others are multiplied, for example, as in a fast DCT implementation.

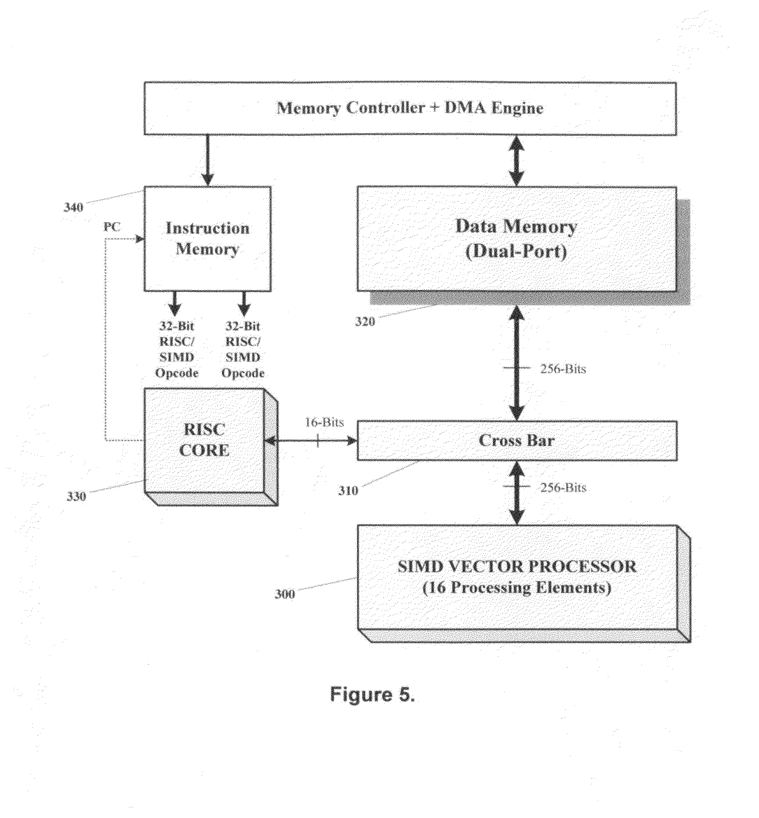

In one embodiment a RISC processor is used together with the SIMD processor as a dual-issue processor, as shown in FIG. 5. The function of this RISC processor is the load and store of vector registers for SIMD processor, basic address-arithmetic and program flow control. The overall architecture could be considered a combination of Long Instruction Word (LIW) and Single Instruction Multiple Data Stream (SIMD). This is because it issues two instructions every clock cycle, one RISC instruction and one SIMD instruction. SIMD processor can have any number of processing elements. RISC instruction is scalar working on a 16-bit or 32-bit data unit, and SIMD processor is a vector unit working on 16 16-bit data units in parallel.

The data memory in this preferred embodiment is 256-bits wide to support 16 wide SIMD operations. The scalar RISC and the vector unit share the data memory. A cross bar is used to handle memory alignment transparent to the software, and also to select a portion of memory to access by RISC processor. The data memory is dual-port SRAM that is concurrently accessed by the SIMD processor and DMA engine. The data memory is also used to store constants and history information as well input as input and output video data. This data memory is shared between the RISC and SIMD processor.

While the DMA engine is transferring the processed data block out or bringing in the next 2-D block of video data, the vector processor concurrently processes the other data memory module contents. Successively, small 2-D blocks of video frame such as 64 by 64 pixels are DMA transferred, where these blocks could be overlapping on the input for processes that require neighborhood data such as 2-D convolution.

SIMD vector processor simply performs data processing, i.e., it has no program flow control instructions. RISC scalar processor is used for all program flow control. RISC processor also additional instructions to load and store vector registers.

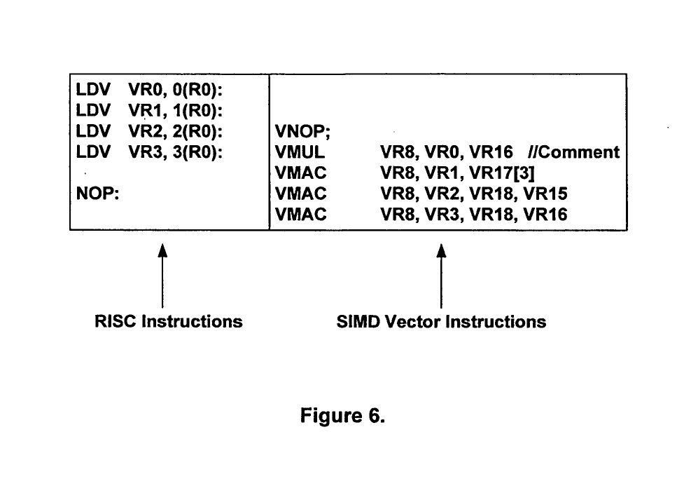

Each instruction word is 64 bits wide, and typically contains one scalar and one vector instruction. The scalar instruction is executed by the RISC processor, and vector instruction is executed by the SIMD vector processor. In assembly code, one scalar instruction and one vector instruction are written together on one line, separated by a colon “:”, as shown in FIG. 6. Comments could follow using double forward slashes as in C++. In this example, scalar processor is acting as the I/O processor loading the vector registers, and vector unit is performing vector-multiply (VMUL) and vector-multiply-accumulate (VMAC) operations. These vector operations are performed on 16 input element pairs, where each element is 16-bits.

If a line of assembly code does not contain a scalar and vector instruction pair, the assembler will infer a NOP for the missing instruction. This NOP could be explicitly written or simply omitted.

In general, RISC processor has the simple RISC instruction set plus vector load and store instructions, except multiply instructions. Both RISC and SIMD has register-to-register model, i.e., operate only on data in registers. In the preferred embodiment RISC has the standard 32 16-bit data registers. SIMD vector processor has its own set of vector register, but depends on the RISC processor to load and store these registers between the data memory and vector register file.

Some of the other SIMD processors have multiple modes of operation, where vector registers could be treated as byte, 16-bit, or 32-bit elements. The present invention uses only 16-bit to reduce the number of modes of operation in order to simplify chip design. The other reason is that byte and 32-bit data resolution is not useful for video processing. The only exception is motion estimation, which uses 8-bit pixel values. Even though pixel values are inherently 8-bits, the video processing pipeline has to be 16-bits of resolution, because of promotion of data resolution during processing. The SIMD of present invention use a 48-bit accumulator for accumulation, because multiplication of two 16-bit numbers produces a 32-bit number, which has to be accumulated for various operations such as FIR filters. Using 16-bits of interim resolution between pipeline stages of video processing, and 48-bit accumulation within a stage produces high quality video results, as opposed to using 12-bits and smaller accumulators.

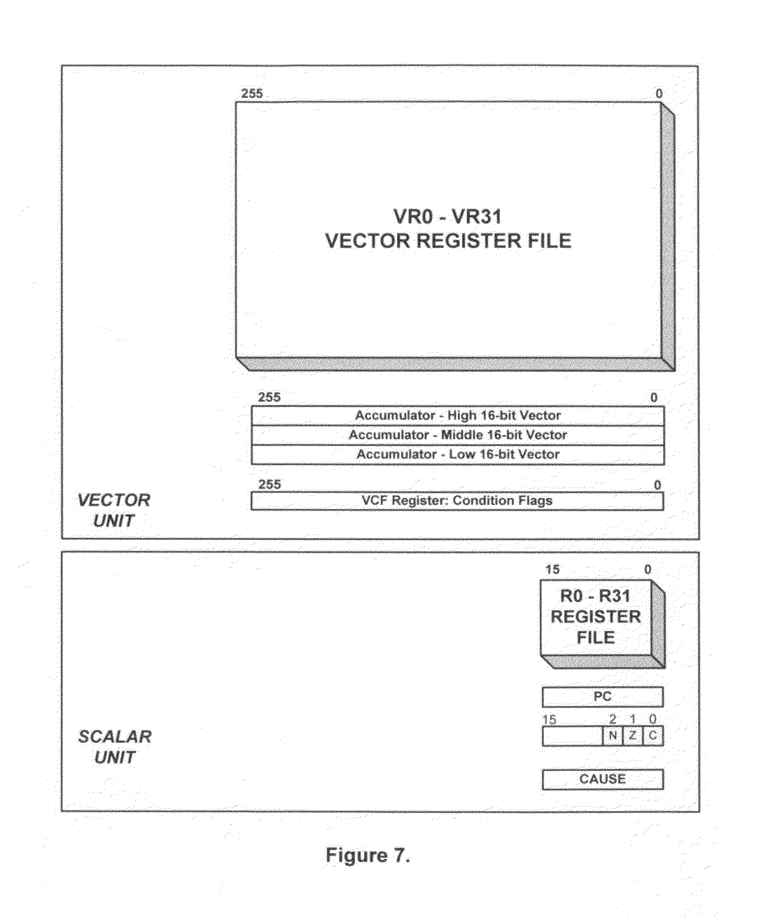

The programmers' model is shown in FIG. 7. All basic RISC programmers' model registers are included, which includes thirty-two 16-bit registers. The vector unit model has 32 vector register, vector accumulator registers and vector condition code register, as the following will describe. The vector registers, VR31-VR0, form the 32 256-bit wide register file as the primary workhorse of data crunching. These registers contain 16 16-bit elements. These registers can be used as source and destination of vector operations. In parallel with vector operations, these registers could be loaded or stored from/to data memory by the scalar unit.

The vector accumulator registers are shown in three parts: high, middle, and low 16-bits for each element. These three portions make up the 48-bit accumulator register corresponding to each element position.

There are sixteen condition code flags for each vector element of vector condition flag (VCF) register. Two of these are permanently wired as true and false. The other 14 condition flags are set by the vector compare instruction (VCMP), or loaded by LDVCR scalar instruction, and stored by STVCR scalar instruction. All vector instructions are conditional in nature and use these flags.

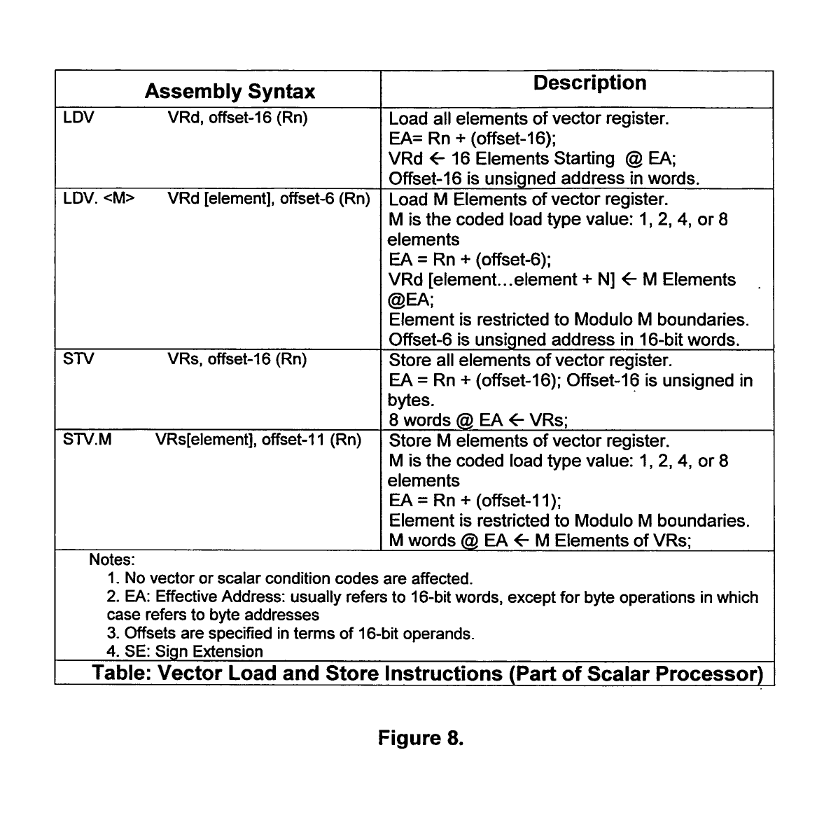

FIG. 8 shows an example of the vector load and store instructions that are part of the scalar processor in the preferred embodiment, but also could be performed by the SIMD processor in a different embodiment. Performing these by the scalar processor provides the ability to load and store vector operations in parallel with vector data processing operations, and thus increases performance by essentially “hiding” the vector input/output behind the vector operations. Vector load and store can load the all the elements of a vector register, or perform only partial loads such as loading of 1, 2, 4, or 8 elements starting with a given element number (LDV.M and STV.M instructions).

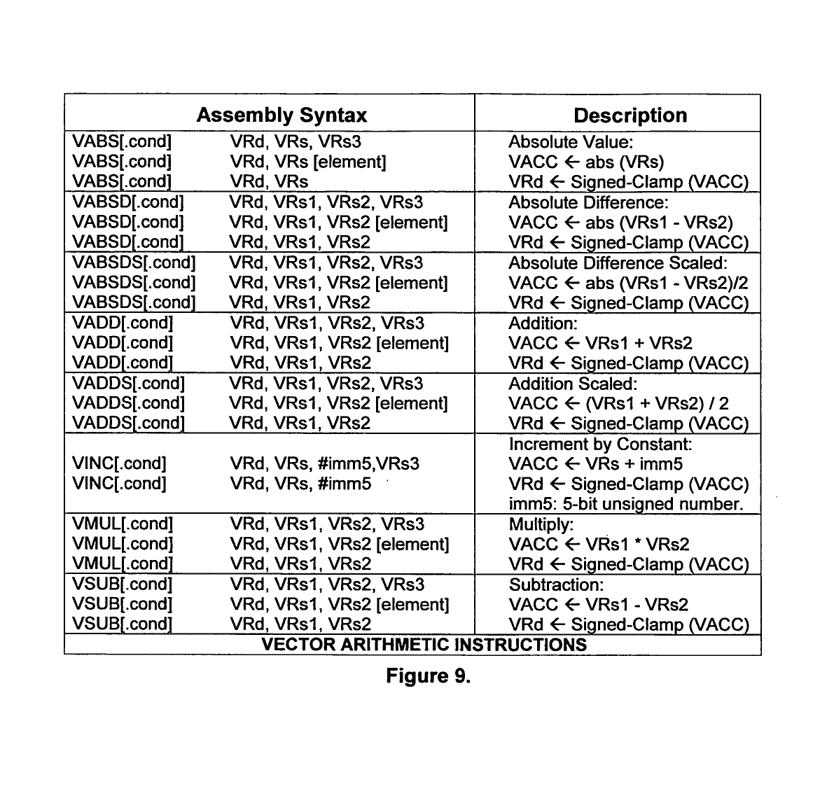

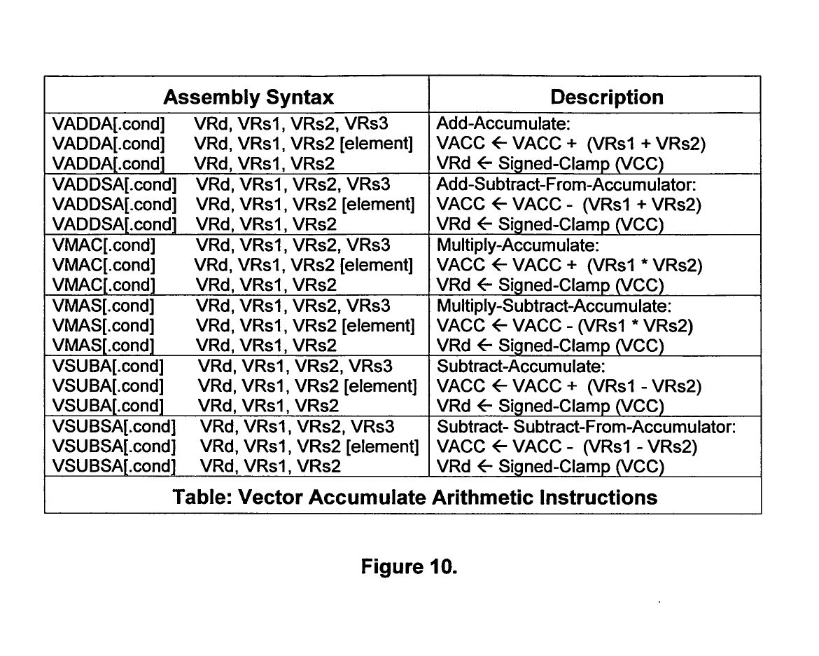

FIG. 9 shows an example of the vector arithmetic instructions. All arithmetic instructions results are stored into vector accumulator. If the mask bit is set, or if the condition flag chosen for a given vector element position is not true, then vector accumulator is not clamped and written into selected vector destination register. FIG. 10 shows an example list of vector accumulator instructions.

Vector Compare instruction VCMP uses vector comparison unit 170 shown in FIG. 1, where two vector inputs to be compared are from the output of select logic 150 and 160. VCMP subtract respective elements of SOURCE_1 and SOURCE_2 and sets the selected condition flags of vector condition flag (VCF) register accordingly. In the preferred embodiment, VCF register is 256 bits, and contains 16 condition flags for each vector element position. For each of these vector element positions, bit #0 is wired to one, and bit #1 is wired to zero directly. The Vector Compare Instruction (VCMP) sets the other fourteen bits. These fourteen bits are grouped as seven groups of two bits. One of these two bits correspond to the condition for the “if” part and the other one corresponds to the “else” condition that is calculated by VCMP instruction.

VCMP instruction has the following formats:

| | |
|---|---|
| VCMP[Test].[Cond] | Group-d, VRs-1, VRs-2 |
| VCMP[Test].[Cond] | Group-d, VRs-1, VRs-2[element] |
| VCMP[Test].[Cond] | Group-d, VRs-1, VRs-2, VRc |

The first format compares respective vector elements of VRs-1 and VRs-2, which is the typical operation of pairing vector elements of two source vectors. The second format compares one element (selected by element number) of VRs-2 across all elements of VRs-1. The third format compares any element of {VRs-1∥VRs-2} with any element of {VRs-1∥VRs-2}, where the user-defined pairing of elements is determined by vector control register VRc elements. Based on the assembly syntax, one of the above three formats are chosen and this is coded by format field of the instruction opcode.

### Where:

Test Selects one of the conditions to calculate such as Greater-Than (GT), Equal (EQ), Greater-Than-or-Equal (GE), Less-Than (LT), Less-Than-or-Equal (LE), etc, and generates a single one-bit condition flag for “if” condition (condition true) and one-bit condition flag for “else” (condition false) condition. Such calculation of final single-bit condition flags for a complex target condition such as greater-than-or-equal-to is referred to as aggregation of test condition into a single condition flag herein. The preferred embodiment of VCMP instruction has 6 variants, and these are: VCMPGT, VCMPGE, VCMPEQ, and VCMPLT. These are coded as part of the overall 6-bit vector instruction opcode field, i.e., as six different vector instructions.
Cond Since VCMP itself is also conditional, as the other vector instructions, this field selects one of the 16 conditions to be logically AND'ed with calculated condition flags for each vector element by VCMP instruction. This is referred to as compounding of condition flags herein. This field has 16 bits. If there is no parent condition, or “Cond” field is left out in assembly syntax of an instruction, then this field selects hardwired always-true condition.
Group-d This field selects one of the 7 groups as the destination of this vector instruction. Each group contains two condition bits calculated by the VCMP instruction, one for the “if” branch, and one for the “else” branch. The possible values for this pair of binary numbers is (1,0), (0,1), and (0,0), where the last one corresponds to the case where the parent branch condition is false. This field uses 14 bits, and hardwired (1,0) pair is reserved for always-true and always-false conditions. For example, for the above-mentioned embodiment with 16 vector elements, and 16-bits per vector element of VCF, we have 7 possible if-else destination groups in VCF for each vector element position, settable by VCMP instruction, and 8^{th} group is the hardwired (1,0) pair.
VRs-1 Vector Source register #1 to be used in testing.
VRs-2 Vector Source register #2 to be used for testing.
VRc Mapping control vector register. Also, referred to as VRs-3 or Vector

Source register #3. Defines the element-to-element mapping to be used for vector comparison. In other words, the comparison, may not be between corresponding elements, but may have arbitrary cross or intra element mapping. If no VRc is used in assembly coding and delta condition is not selected, this defaults to one-to-one mapping vector elements.
VCMP Element i of VRs-2 is subtracted from element j of VRs-1 based on the mapping defined by VRc, and according to the test condition specified, and two condition flags of selected condition group is set to one or zero in accordance with test field defining a comparison test to be performed, parent condition flag selected by “Cond” field, and mask bit and mapping control defined by control vector VRc. Elements of source vector registers #1 and #2 are mapped as defined by VRc vector register before the subtract operation.
Element Defines one of the elements for comparing a selected element of source vector #2 with all elements of source vector #1.
   The operation of VCMP[Test] instruction is defined below in C-type pseudo code:

```
for (i = 0; i < 16; i++) if (VRc(i)₁₅ == 0) //Each element
condition enabled if mask bit is 0.
  {
    Group = Group-d;
    Case (Format)
  {
    0: map_source_1 = VRc[i]_{5..0};
    map_source_2 = VRc[i]_{10..6};
    break;
    1: map_source_1 = i;
    map_source_2 = Element;
    break;
default:
    map_source_1 = i;
    map_source_2 = i;
    break;
  }
    Source_2 = (Vs-1 || Vs-2)[map_source_2];
    // Mapping of Source-1 and Source-2 elements.
    Source_1 = (Vs-2 || Vs-1) [map_source_1];
    parent_condition = Cond[i];
case (Test)
  {
  GT:
    Condition ← (Source_1 - Source_2) > 0;
    VCR [i]_{Group} ← Condition & parent_condition;
    VCR [i]_{Group+1} ← ! Condition & parent_condition;
    break;
  GE:
    Condition ← (Source_1 - Source_2) >= 0;
    VCR [i]_{Group} ← Condition & parent_condition;
    VCR [i]_{Group+1} ← ! Condition & parent_condition;
    break;
  LT:
    Condition ← (Source_1 - Source_2) < 0;
    VCR [i]_{Group} ← Condition & parent_condition;
    VCR [i]_{Group+1} ← ! Condition & parent_condition;
    break;
  LE:
    Condition ← (Source_1 - Source_2) <= 0;
    VCR [i]_{Group} ← Condition & parent_condition;
    VCR [i]_{Group+1} ← ! Condition & parent_condition;
    break;
  EQ:
    Condition ← (Source_1 - Source_2) == 0;
    VCR [i]_{Group} ← Condition & parent_condition;
    VCR [i]_{Group+1} ← ! Condition & parent_condition;
    break;
  NE:
    Condition ← (Source_1 - Source_2) != 0;
    VCR [i]_{Group} ← Condition & parent_condition;
    VCR [i]_{Group+1} ← ! Condition & parent_condition;
    break;
        }
  }
```

Where “!” signifies logical inversion, and “&” signifies logical AND operation, and “abs” signifies absolute-value operation. “II” signifies concatenation of vector elements. For example, to implement a single level of if-then-else is as follows:

| Pseudo C-Code | Pseudo Vector Assembly Code |
|---|---|
| if (x > y) | VCMPGT c2, Vs1, Vs2 |
| { | |
| Operation_1; | V[Operation-1].c2i <Operands> |
| Operation_2; | V[Operation-2].c2i <Operands> |
| ... | |
| } | |
| else | |
| { | |
| Operation_3; | V[Operation-3].c2e <Operands> |
| Operation_4; | V[Operation-4].c2e <Operands> |
| ... | |
| } | |

We omitted condition code field on VCMPGT, which then defaults to non-conditional execution. Here we assume that operands are already loaded in vector registers. VRs-1 contains x and VRs-2 contains y value. This shows that actually there is less vector assembly instructions that C-level instructions. The preferred embodiment of present invention uses a dual-issue processor, where a tightly coupled RISC processor handles all loading and storing of vector registers. Therefore, it is reasonable to assume that vector values are already loaded in vector registers.

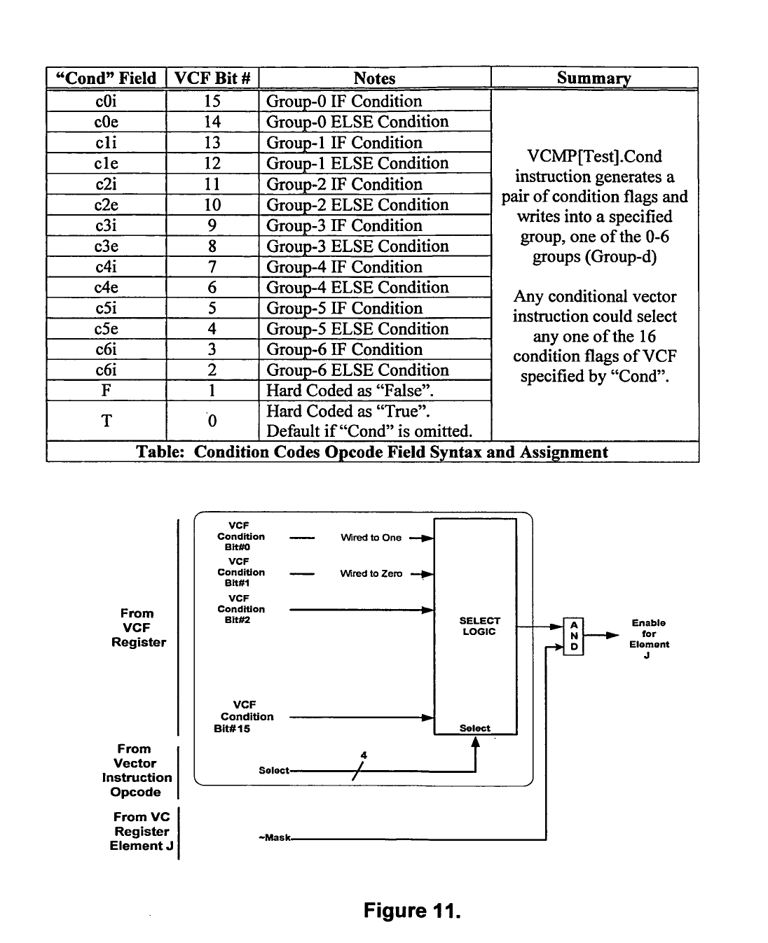

FIG. 11 shows the assembly syntax of condition code selection and the selection of condition flag and logical AND of selected condition flag with the mask bit. “c2” defines the group of Condition-2, which is nothing but one of the 16 condition flags. The “c2i” defines the “if” part of the vector condition, and “c2e” defines the “else” part condition two group. This is to facilitate readability; otherwise number field of [3:0] could, as it is coded in the instruction opcode, and c2i and c2e correspond to numbers 2 and 3 in preferred embodiment.

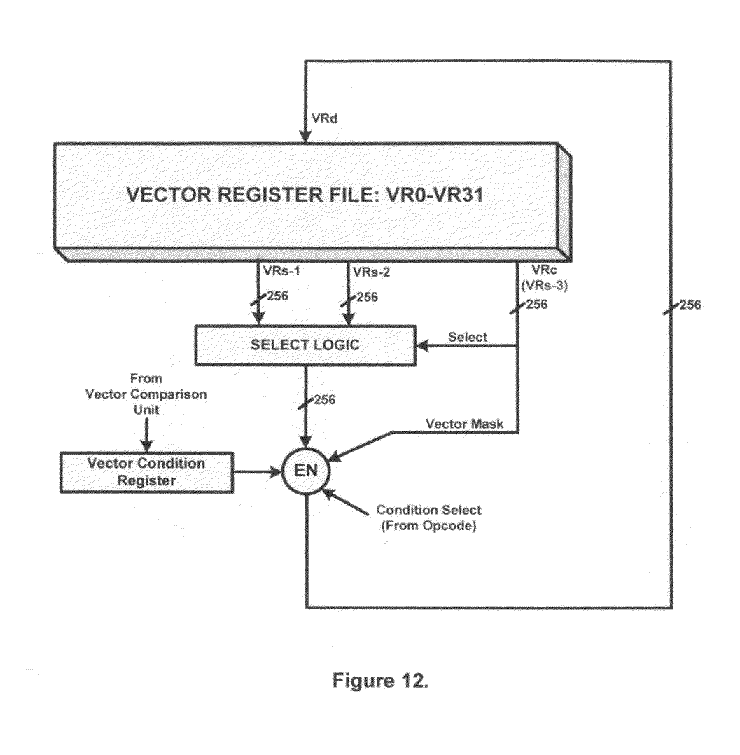

Vector compare instruction of present invention also provides ability for parallel sorting and acceleration of data sorting algorithms in conjunction with a vector multiplex instruction by a factor of over N times over scalar methods for a N-wide SIMD embodiment. Vector multiplex (VMUX) instruction uses the same basic structure of SIMD processor but has only one source vector (see FIG. 12), which overlays with FIG. 1, but one of the select logic is used to map elements of two source vectors to a destination vector elements based on the user-defined mapping of a vector control register read from VRc port and vector condition flag register and mask bit dependency. The output of select logic is connected to a enable-logic (EN) which conditionally stores the output elements of select logic output based on selected condition flag and mask bit for each vector element position. The mapping of two source vector elements to a destination vector elements are performed in parallel in substantially one pipelined clock cycle.

VMUX mapping instruction uses a source-vector register (VRs), a mapping control vector register (VRc), and destination vector register (VRd), as:

VMUX.[Cond] VRd, VRs-1, VRs-2, VRc

Where“[Cond]” specifies the condition code, selecting one of the condition flags for each element of VCF register, if the mapping is to be enabled based on each element's condition code flags. If condition code flags are not used, then the condition “True” may be used, or simply omitted.

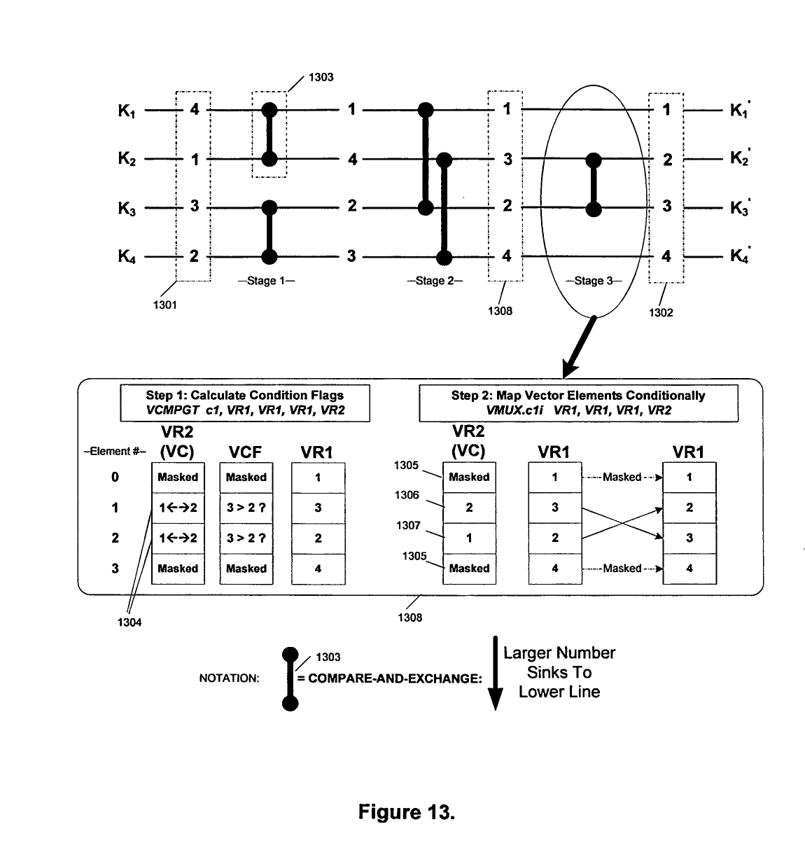

An example of vector conditional mapping for ordering the elements of an 4-element vector is shown in FIG. 13, where a three stage algorithm (Donald Knuth, Sorting and Searching, p. 221, Addison Wesley, 1998) with input vector of {4,1,3,2} 801. Here numbers enter at the left, and comparator modules are represented by vertical connections between two lines; each comparator module 1303 causes an interchange of its inputs, if necessary, so that larger number sinks to the lower line after passing the comparator. Each stage of sorting could be performed with one VCMP and one VMUX instruction. The stage 3 has {1,3,2,4} 1308 input vector, where we compare elements 1 and 2 at 1304 and set the same condition flag in elements 1 and 2 of VCF. For VMUX instruction, VRc is set so that element 1 of VR1 is sourced from element 2 at 1307, and element 2 is sourced from element 1 at 1306. The elements 0 and 3 are masked 1305 regardless of the VCF flag for these. The resultant vector is {1,2,3,4} 1302.

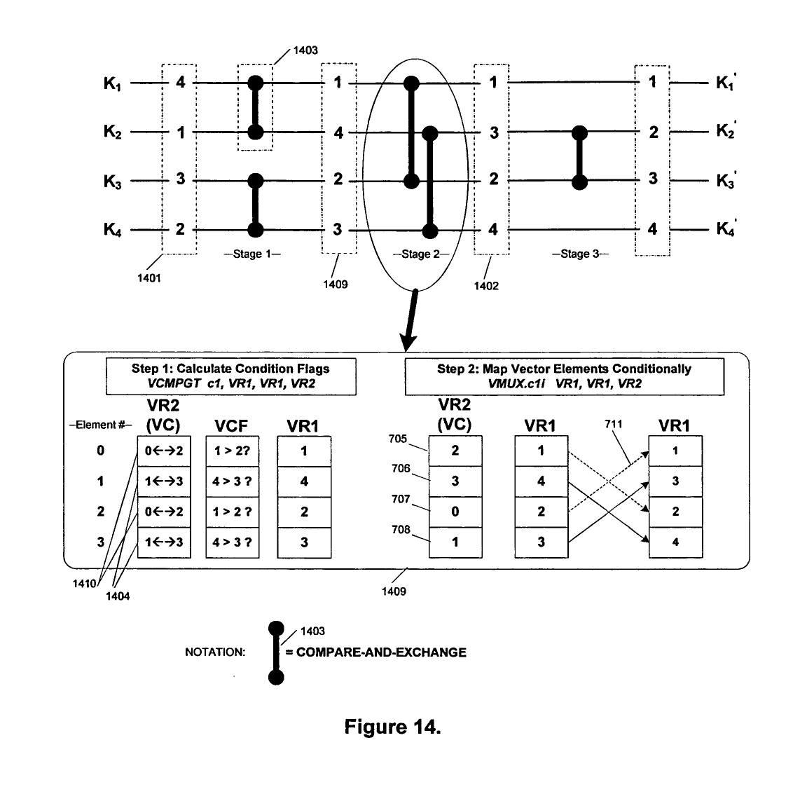

The sorting for stage 2, shown in FIG. 14, has {1,4,2,3} 1409 input vector, where we compare elements 0 and 2 for two vector element positions 1410, and 1 and 3 at two vector positions 1404 and set the same condition flag in VCF. For VMUX instruction, VRc is set so that element 0 of VR1 is sourced from element 2 at 1407, element 1 is sourced from 3 at 1408, element 2 is sourced from element 0 at 1405, and element 3 is sourced from element 1 at 1406. The dashed lines 1411 indicate data moves that was not performed because corresponding condition code flags were false. The resultant vector is {1,3,2,4} 1402.

This example shows that sequence of 4 numbers could be sorted into ascending or descending order in 6 vector instructions of the present inventions: 3 stages×(1 VCMP+1 VMUX) per stage. Since the example embodiment used is a 16-wide SIMD, this means four sets of 4 four numbers could be concurrently sorted out in parallel. Scalar implementation would require 8, 8, and 4 compare and exchange operations for stages 1, 2 and 3, respectively. Assuming compare-and-exchange requires 3 instructions (compare-branch-and exchange), the total instructions is 60. This means an acceleration by a factor of over 60/6, or 10×, but actual acceleration is much higher since each branch instruction of scalar compare requires multiple clock cycles.

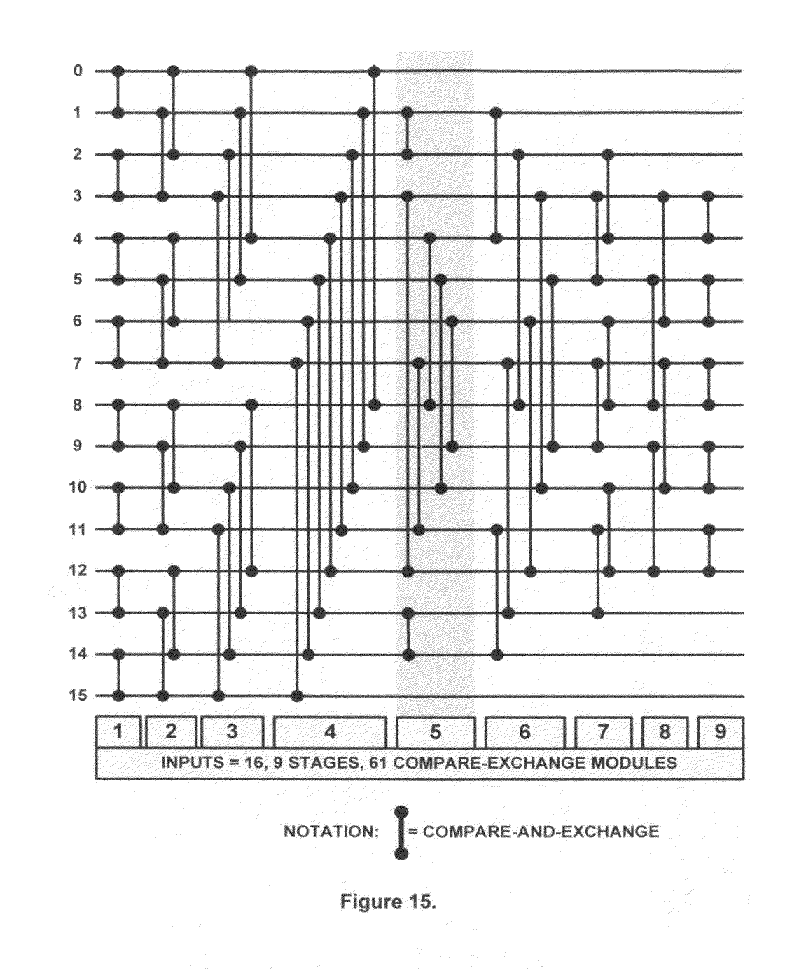

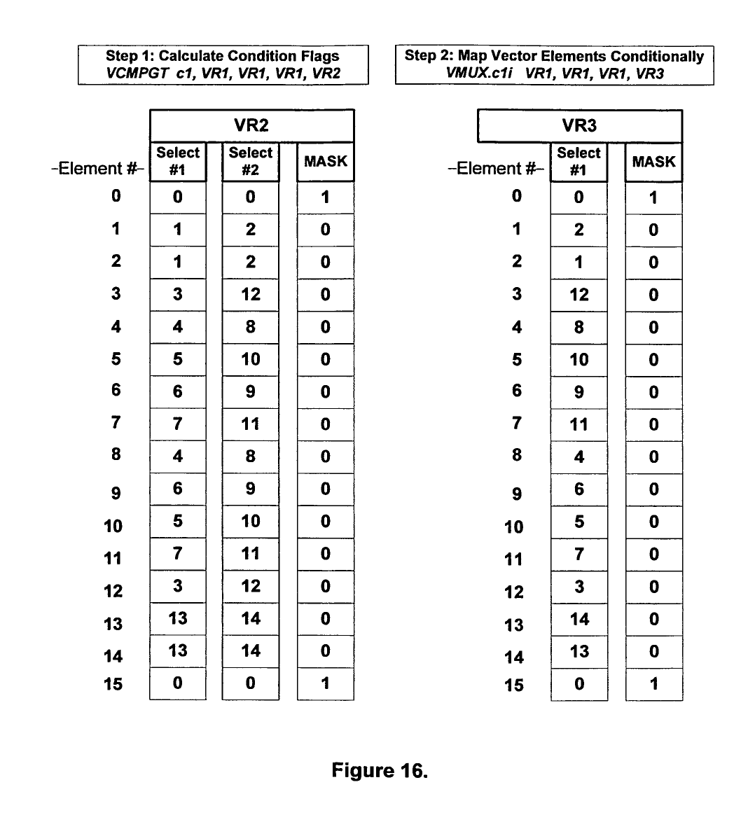

FIG. 15 shows data array sorting algorithm from the same reference for an array of 16 inputs. This algorithm requires 9 stages and 61 compare-exchange modules. The method of present invention performs this sorting in 9 pairs of VCMP and VMUX instructions as shown in FIG. 16 for stage 5. Such sorting could also be used in video processing applications where rank filter or median filter sorts the array of pixels in the neighborhood of a pixel and selects the output pixel from a certain rank of the sorted array of pixels.

The present invention requires only 18 instructions to sort 16 numbers. The ability to compare any element of two source vectors removes the need to load different offsets to gain access to different vector elements to be able to match different vector elements for comparison and exchange. Furthermore, in the preferred embodiment, vector input/output is performed in parallel with vector comparison and exchange operations.

1. (canceled)

2. A processor for performing sorting of data arrays in parallel, the processor comprising:
a vector register file for holding a first source vector operand, a second source vector operand, and at least one control vector as a third source vector operand, wherein each vector register of said vector register file holds a plurality of vector elements of a predetermined size, each of said plurality of vector elements defining one of a plurality of vector element positions;
a vector condition flag register for storing at least one condition flag for each of said plurality of vector element positions, said at least one condition flag defining a true or false condition value;
a first select logic coupled to said vector register file for each of said plurality of vector element positions for selecting from a first group of at least elements of said first source vector operand in accordance with said at least one control vector;
a second select logic coupled to said vector register file for each of said plurality of vector element positions for selecting from a second group of at least elements of said second source vector operand in accordance with said at least one control vector;
a vector operation unit coupled to output of said first select logic and said select second logic, each element of said vector operation unit having a first input and a second input; and
a vector compare unit coupled to output of said first select logic and said second select logic for comparing respective vector elements when invoked by a vector compare instruction in accordance with a test field defined of said vector compare instruction, and generating a condition flag for each of said plurality of vector element positions.

3. The processor according to claim 2, wherein both said first group and said second group includes vector elements of said first source vector operand and said second source vector operand.

4. The processor according to claim 2, further including:
a vector mask unit coupled to output of said vector operation to control storing of output vector elements to a destination vector register in accordance with said at least one condition flag of each respective vector element of said vector condition flag register on a vector element-by-element basis.

5. The processor according to claim 4, wherein writing of output vector elements to said destination vector register is further controlled in accordance with a respective mask bit of said control vector on a vector element-by-element basis.

6. The processor according to claim 2, wherein said vector compare instruction followed by a vector multiplex instruction performs multiple compare-and-exchange (1303) operations in two clock cycles, said vector multiplex instruction uses mapping of said first source vector operand and said second source vector operand in accordance with said control vector and said at least one condition flag of each respective vector element of said vector condition flag register on a vector element-by-element basis.

7. The processor according to claim 2, further including means for performing data array sorting in parallel.

8. The processor according to claim 2, wherein number of vector elements for each vector register is an integer between 2 and 1025.

9. The processor according to claim 2, wherein each vector element size is one of 16-bits, 32-bits, and 64-bits.

10. The processor according to claim 2, wherein each vector element stores a fixed-point or a floating-point number.

11. A method for parallel and programmable implementation of data array sorting, the method comprising:
storing a first source vector to be a first operand of a vector instruction;
storing a second source vector to be a second operand of said vector instruction;
storing a control vector to be a third operand of said vector instruction; and
a vector compare instruction performing steps comprising:
selecting, in accordance with a first designated field of each vector element of said control vector, from a first group comprising elements of said first source vector, to generate a first mapped vector, said first mapped vector being the same size as said first source vector and said second source vector;
selecting, in accordance with a second designated field of each vector element of said control vector, from a second group comprising elements of said second source vector, to generate a second mapped vector, said second mapped vector being the same size as said first source vector and said second source vector; and
comparing elements of said first mapped vector and said second mapped vector for a selected comparison test and calculating a test condition flag for each vector element position.

12. The method according to claim 11, further comprising:
a vector multiplex instruction performing steps comprising:
selecting, in accordance with a first designated field of each vector element of said control vector, from a first group comprising elements of said first source vector, to generate a first mapped vector, said first mapped vector being the same size as said first source vector and said second source vector; and
storing said mapped first vector to a destination vector in accordance with said test condition flag for each vector element position, said destination vector being the same size as said first source vector and said second source vector.

13. The method according to claim 12, further including steps for sorting a data array of different sizes according to a multi-stage compare-and-exchange algorithm.

14. The method according to claim 11, wherein said vector instruction is a vector-comparison instruction which performs all respective steps in a single clock cycle.

15. The method according to claim 12, wherein said vector multiplex instruction which performs all respective steps in a single clock cycle.

16. The method according to claim 12, wherein number of vector elements of source vector is 16, and four sets of sorting a data array of 4 elements each can be performed in parallel and results can be obtained in three stages, each stage requiring one clock cycle for said vector compare instruction and one clock cycle for said vector multiplex instruction.

17. The method according to claim 12, wherein number of vector elements of source vector is 16, and sorting a data array of 16 elements can be performed in parallel and results can be obtained in nine stages, each stage requiring one clock cycle for said vector compare instruction and one clock cycle for said vector multiplex instruction.

18. An execution unit for use in a computer system for sorting data arrays, the execution unit comprising:
A first vector register and a second vector register for holding respective a first source vector operand and a second source vector operand, wherein each of said first vector register and said second vector register holds a plurality of vector elements of a predetermined size, each vector element defining one of a plurality of vector element positions;
means for mapping said first source vector operand;
means for mapping said second source vector operand;
a control vector for controlling mapping of said first source operand and said second source vector operand;
a vector condition flag register for storing a plurality of condition flags for each of said plurality of vector element positions, each element of said plurality of condition flags defining a true or false condition value;
a plurality of operators associated respectively with said plurality of vector element positions for carrying out said vector operation on respective vector elements of said first source vector operand and said second source vector operand;
a vector compare unit for comparing said mapped first source vector operand and said mapped second source vector operand in accordance with a test field defined in an instruction, and generating a test condition flag for each of said plurality of vector element positions; and
a vector mask unit for controlling storing the output of said plurality of operators to a destination vector register in accordance with a selected at least one of said plurality of condition flags of each respective vector element of said vector condition flag register on a vector element-by-element basis.

19. The execution unit according to claim 18, wherein a vector compare instruction compares elements of said first vector register and said second vector register in a single clock cycle in accordance with pairing of elements as inputs to said vector compare unit for each element position as defined by said control vector and in accordance with a selected comparison test to be performed defined by said vector compare instruction.

20. The execution unit according to claim 18, wherein a vector multiplex instruction maps elements of said first vector register and said second vector register in a single clock cycle in accordance with said control vector and a selected condition flag of said vector condition flag register in accordance with said vector multiplex instruction.

21. The execution unit according to claim 18, further including means for sorting data arrays in parallel.
